(19) United States
(12) Patent Application Publication
(10) Pub. No.: US 2011/0047515 A1
(43) Pub. Date: Feb. 24, 2011

(54) THREE-DIMENSIONAL NAVIGATION SYSTEM FOR CONTENTS GUIDE AND METHOD THEREOF

(75) Inventors: Jun Kyun Choi, Daejeon (KR); Hyojin Park, Daejeon (KR); Jinhong Yang, Daejeon (KR)

Correspondence Address: PEARNE & GORDON LLP, 1801 EAST 9TH STREET, SUITE 1200, CLEVELAND, OH, 44114-3108, US

(73) Assignee: KOREA ADVANCED INSTITUTE OF SCIENCE AND TECHNOLOGY, Daejeon (KR)

(21) Appl. No.: 12/644,166

(22) Filed: Dec. 22, 2009

(30) Foreign Application Priority Data
Aug. 21, 2009 (KR) 10-2009-0077770

(51) Int. Cl. G06F 3/048

(52) U.S. Cl. 715/851

(57) ABSTRACT

Disclosed is a three dimensional (3D) navigation system for contents guide and a method thereof. The contents guide navigation system includes a contents classification module to classify contents based on at least one tag defined in the contents, and a navigation module to provide a list of the classified contents via a 3D guide screen constituted by an x axis, a y axis, and a z axis. Here, the navigation module links the list of the classified contents to the x axis, the y axis, and the z axis, each of the x axis, the y axis and the z axis being linked on different standards.

### CROSS-REFERENCE TO RELATED APPLICATION

This application claims the benefit of Korean Patent Application No. 10-2009-0077770, filed on Aug. 21, 2009, in the Korean Intellectual Property Office, the disclosure of which is incorporated herein by reference.

### BACKGROUND

1. Field of the Invention

Example embodiments of the present invention relate to a contents guide 3D navigation system and method that provides a guide with respect to a contents list to enable a user to conveniently select desired contents.

2. Description of the Related Art

A broadcasting environment has been divided according to different media being used such as a ground wave, a cable, a satellite, and the like, and now the divided broadcasting environments are gradually becoming integrated. Recently, an Internet protocol television (IPTV) environment that may provide a service based on an Internet protocol (IP) is developed and related standards are also developed. The IPTV is an interactive television service that is provided by a high-speed Internet, and has an advantage that a viewer is able to watch a desired program at a convenient time compared with a general cable broadcast.

A broadcasting receiver of the broadcasting environment generally provides programs (hereinafter, broadcasting contents) of a plurality of channels to a user, and thus, contents guide information, as an example, electronic contents guide (ECG), may be provided to enable the user to easily select desired broadcasting contents from the plurality of channels. That is, the contents guide information is guidance information with respect to broadcasting contents that is received by the broadcasting receiver, and is used for providing a convenience of selecting a channel to the user, in a multi-channel era. Accordingly, the user may search for and select the desired broadcasting contents by referring to a contents guide information screen that is displayed on a display unit of the broadcasting receiver.

The contents guide information, which is a type of data, may be extracted by a digital tuning or may be received through a service provider via a network such as the Internet and the like. The contents guide information is transmitted in packets, and includes various additional information for a menu related to the broadcasting contents via a display device. As an example, the contents guide information may include a title of broadcasting contents, a broadcasting time, a number of a channel, a title of a channel, information about an age limit, information about a contents provider, and the like.

Generally, the contents guide information screen classifies a contents list for each channel and for each time and displays all contents guide information on a full guide screen. When the user select the desired broadcasting contents, the user may select a desired channel by performing navigation on the contents guide information screen or may select a channel from a contents guide that is arranged based on an already inputted interest of the user.

However, as the broadcasting environment is integrated into the IPTV, there is a limitation in the contents guide information screen for the user to select the desired contents through a conventional contents guide information in the multi-channel environment where several hundreds channels exists.

### SUMMARY

An aspect of the present invention provides a contents guide three dimensional (3D) navigation system and method thereof that may have a new guide format when a user performs navigation in a list of contents to select contents.

According to an aspect of the present invention, there is provided a contents guide 3D navigation system, including a contents classification module to classify contents based on at least one tag defined in the contents, and a navigation module to provide a list of the classified contents via a 3D guide screen constituted by an x axis, a y axis, and a z axis. Here, the navigation module links the list of the classified contents to the x axis, the y axis, and the z axis, each of the x axis, the y axis and the z axis being linked on different standards.

According to another aspect of the present invention, there is provided a contents guide 3D navigation system, including a contents classification module to classify related-contents related to contents based on at least one tag defined in the contents, when the contents is selected by a user, and a navigation module to provide a list of the classified related-contents via a 3D guide screen constituted by an x axis, a y axis, and a z axis. Here, the navigation module links the list of the classified related-contents to the x axis, the y axis, and the z axis, each of the x axis, the y axis and the z axis being linked on different standards, and displays, on the 3D guide screen, the list of the related-contents linked to at least one of the x axis, the y axis, and the z axis.

The navigation module may link a series list of the contents to the x axis, may link a list of related-contents commonly including a tag selected by the user from among the at least one tag to the y axis, and may link a list of related-contents commonly including remaining tags to the z axis.

According to another aspect of the present invention, there is provided a contents guide 3D navigation method in a system including a contents classification module and a navigation module, the method including classifying, by the contents classification module, related-contents related to contents based on at least one tag defined in the contents, and providing, by the navigation module, a list of the classified related-contents via a 3D guide screen constituted by an x axis, a y axis, and a z axis. Here, the providing links the list of the classified related-contents to the x axis, the y axis, and the z axis, each of the x axis, the y axis and the z axis being linked on different standards, and displays, on the 3D guide screen, the list of the related-contents linked to at least one of the x axis, the y axis, and the z axis

The at last one tag may be defined by a user or a contents provider that provides the contents, and may be a keyword corresponding to at least one contents information of a genre of the contents, a title, an actor, a broadcasting time of the contents, channel information, and a name of the contents provider.

The classifying may include reading a tag defined in selected contents when the contents is selected by the user, and classifying a series of the contents and related-contents commonly including a tag, for each of the read tag.

The providing may link a series list of the series of the contents to the x axis, links a list of related-contents commonly including a tag selected by the user from among the related-contents classified for each tag to the y axis, and may link a list of related-contents commonly including remaining tags to the z axis.

The providing may include displaying, on the 3D guide screen, the series list linked to the x axis and the list of the related-contents linked to the y axis together with a tag list of the tag, and updating the list of the related-contents linked to the y axis as a list of related-contents corresponding to a selected tag from among the list of the related-contents linked to the z axis, when the selected tag is selected from the tag list.

Additional aspects and/or advantages will be set forth in part in the description which follows and, in part, will be apparent from the description, or may be learned by practice of the embodiments.

### EFFECT

According to an embodiment of the present invention, a guide screen in a new format is provided by liking a list of classified contents to an x-axis, a y-axis, and a z-axis, each of the x-axis, the y-axis, and the z-axis being linked on different standards. Particularly, a list of a series of contents is linked to one axis by using a tag predefined in the contents and a list of contents commonly including a tag, for each tag, is linked to another axis, and thus, a guide in a navigation format using a tag is provided. Accordingly, the user easily navigates contents including a same tag based on the tag, and thus, the user may conveniently and easily select desired contents.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an interior format of a contents guide 3D navigation system according to an embodiment of the present invention;

FIG. 2 is a flowchart illustrating a contents guide 3D navigation method according to an embodiment of the present invention;

FIG. 3 is a diagram illustrating a process of linking a contents list for each coordinates to embody a 3D guide screen according to an embodiment of the present invention; and

FIGS. 4 and 5 are diagrams illustrating a contents navigation process through a 3D guide screen according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Embodiments of the present invention relates to a system that provides a guide that enables a user to select desired contents or a menu related to the desired contents. Particularly, an embodiment of the present invention provides a guide format for a three-dimensional (3D) environment when the user navigates a list of contents to select the desired contents.

Particularly, the contents guide 3D navigation system may be applied to a user interface (UI) that provides an electronic program guide (EPG), an electronic contents guide (ECG), an Interactive program guide (IPG), an Interactive contents guide (ICG), a parental guide (PG), and the like, when the contents guide 3D navigation system provides a contents service.

Also, the contents is a generic term of contents provided from all services that are provided over an IP based network, and may include a television service, a video, an audio, a text, an image, a multimedia, and the like.

A 3D navigation system that provides a guide of broadcasting contents will be further described, and, from among the contents, broadcasting contents that is received via a broadcasting receiver, such as an IPTV terminal, a settop box, and the like, is given as an example.

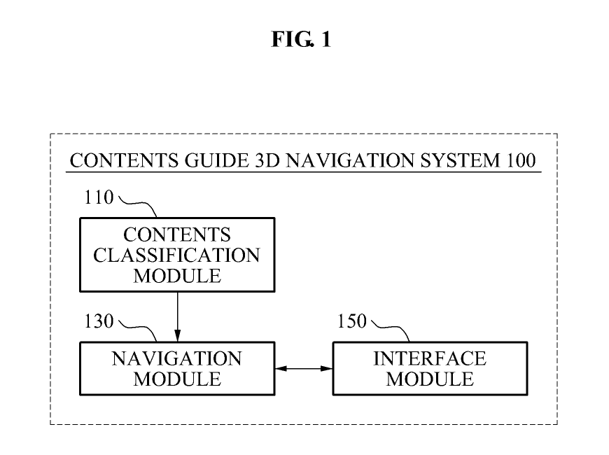

FIG. 1 is a diagram illustrating an interior configuration of a contents guide 3D navigation system 100 according to an embodiment of the present invention.

Referring to FIG. 1, the contents guide 3D navigation system 100 includes the contents classifying module 110, a navigation module 130, and an interface module 150.

An embodiment of the present invention may define and assign at least one tag for each broadcasting contents and may classify the broadcasting contents by using the at least one tag. Also, the at least one tag may be defined by a contents provider or a user, and may be formed in a form of a keyword. The at least one tag may be a keyword corresponding to a genre of broadcasting contents, a title, an actor, a time of providing contents such as a broadcasting time, channel information such as a number of a channel, a title of a channel and the like, a name of a contents provider, and the like.

The contents classifying module 110 classifies the broadcasting contents by using the tag defined in the broadcasting contents. When a user selects specific broadcasting contents, the contents classifying module 110 may classify broadcasting contents related to the selected broadcasting contents, hereinafter related-contents. With respect to each tag of all tags defined in the broadcasting contents, the contents classifying unit 110 may classify a series of the broadcasting contents, as an example, a series of contents of a same program, and may classify related-contents that commonly includes a tag.

The navigation module 130 provides a list of broadcasting contents including the series and the related-contents via a 3D guide screen constituted by an x-axis, a y-axis, and a z-axis. The navigation module 130 may link a list of the series of the selected broadcasting contents to one of the x-axis, the y-axis, and the z-axis based on the broadcasting contents selected by the user, and may link a list of the related-contents classified based on the tag to another axis. The navigation module 130 visualizes and displays, on the 3D guide screen, a list of a tag defined in the selected broadcasting contents and a list linked to at least one axis of the x-axis, the y-axis, and the z-axis, the list being a series list or a related-contents list.

The interface module 150 may receive a user command from an input device, such as a remote controller, a keyboard, and the like, and may perform as an interface that transfers the received user command to the navigation module 130. In this instance, the navigation module 130 may receive the user command from the interface module 150, and may control navigation in the 3D guide screen or selects specific broadcasting contents.

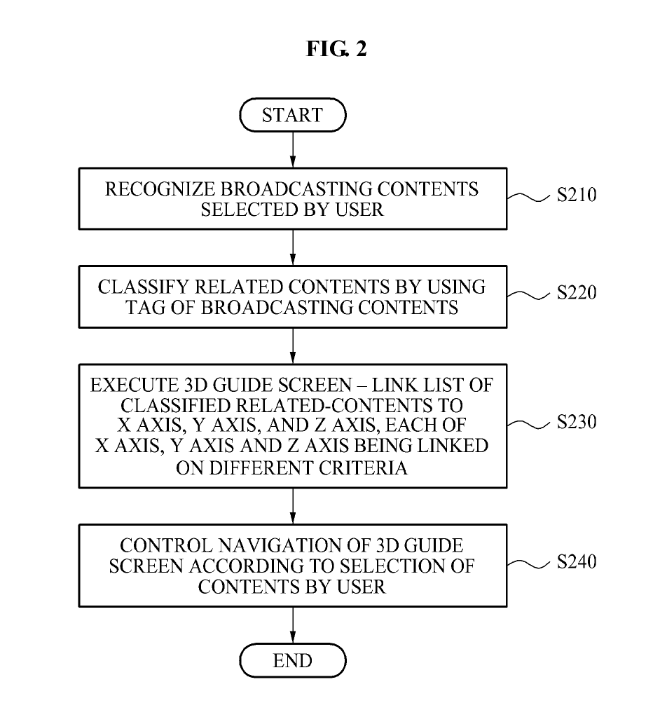

FIG. 2 is a flowchart illustrating a contents guide 3D navigation method according to an embodiment of the present invention. The contents guide 3D navigation method according to an embodiment of the present invention may be performed by the contents guide 3D navigation system 100 of FIG. 1.

In operation S210, the contents guide 3D navigation system 100 recognizes broadcasting contents selected by a user, hereinafter, a reference contents, and reads a at least one tag defined in the reference contents.

In operation S220, the contents guide 3D navigation system 100 classifies related-contents related to the reference contents by using the at least one tag of the reference contents. With respect to each tag of all tags defined in the reference tag, the contents guide 3D navigation system 100 classifies a series of the reference contents and classifies related contents including a tag.

In operation S230, the contents guide 3D navigation system 100 executes a 3D guide screen that provides a list of the series of the reference contents and a list of the related-contents classified for each tag. The contents guide 3D navigation system 100 links the list of the classified contents to an x axis, a y axis, and a z axis, each of the x axis, the y axis and the z axis being linked on different standards, and visually displays, on the 3D guide screen, the list of the contents that is linked to at least one of the x axis, the y axis, and the z axis.

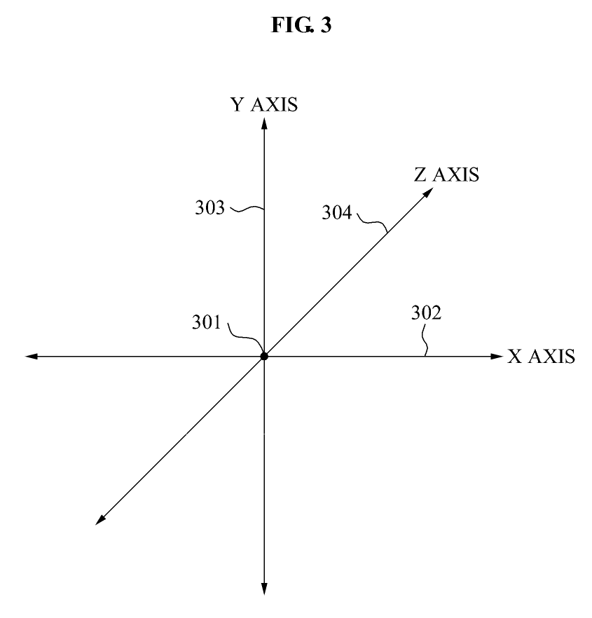

FIG. 3 is a diagram illustrating a process of linking contents for each coordinates to embody a 3D guide screen according to an embodiment of the present invention.

As an example, as illustrated in FIG. 3, the contents guide 3D navigation system 100 links reference contents to an origin 301 of coordinates and links a list of a series of the reference contents to an x-axis 302 based on the origin 301. Also, the contents guide 3D navigation system 100 links, to a y-axis 303, a list of related-contents that commonly includes a specific tag, as an example a tag selected by a user, among tags of the reference contents, and links, to a z-axis 304, a list of related-contents that commonly includes another tag that is different from the specific tag among the tags of the reference contents.

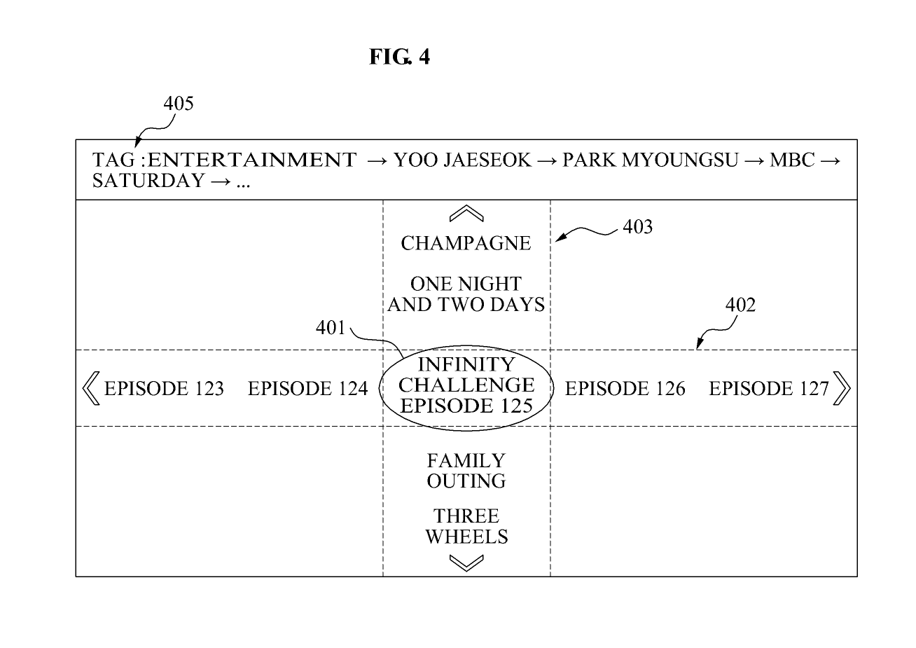

FIG. 4 is a diagram illustrating a visualized 3D guide screen according to an embodiment of the present invention.

As an example, as illustrated in FIG. 4, the contents guide 3D navigation system visually displays 100, on the 3D guide screen, a reference contents 401 linked to an origin, a series list 402 of a series of a reference contents, the series list 402 linked to an x-axis, and a related-contents list 403 of related-contents including a same tag as a specific tag, the related-contents list 403 linked to a y-axis. The contents 3D navigation system 100 may display, on the 3D guide screen, a tag list 405 of all tags defined in the reference contents 401. When another tag is selected through the tag list 405, the related-contents list 403 linked to the y axis is updated as a related-contents list of related-contents corresponding to the selected tag among a related-contents list linked to a z-axis.

In operation S240, the contents guide 3D navigation system 100 controls navigation with respect to the contents list according to a selection of a tag or contents by the user through the 3D guide screen. As an example, when a motion recognition remote controller is used as an input device for inputting a user command, the navigation of the 3D guide screen is controlled by mapping a left/right motion of the motion recognition remote controller to a movement command with respect to the x-axis, mapping an up/down motion to a movement command with respect to the y-axis, and mapping a forward/backward motion to a movement command with respect to the z-axis. Referring to FIG. 4, when the user command is a left/right movement command of an x-axis direction, navigation with respect to the series list 402 is performed by moving the series list 402 left/right, the series list 402 being based on the reference contents 401, and when the user command is an up/down movement command of a y-axis direction, the navigation with respect to the related-contents list 403 is performed by moving the related-contents list 403 up/down, the related-contents being based on the reference contents 401. Also, when the user command is a forward/backward movement command of a z-axis direction, the contents guide 3D navigation system performs navigation with respect to the tag list 405 by moving the tag list 405 forward/backward.

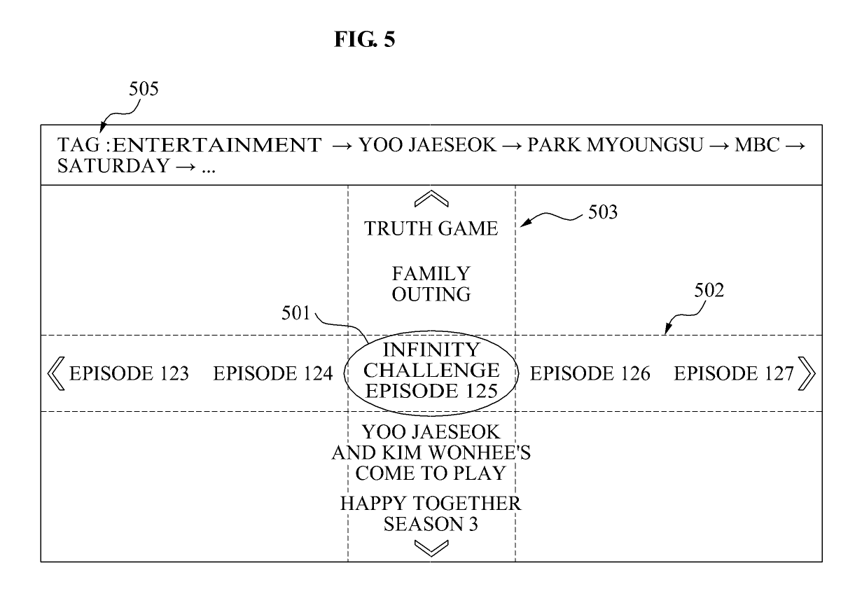

The user may select desired contents by navigating in the series list 402 or the related-contents list 403 through the 3D guide screen provided by the contents guide 3D navigation system 100. When the user selects another tag from the tag list 405, the contents guide 3D navigation system 100 may update the currently displayed related-contents list 403 as a related-contents list 503 of related-contents commonly including a newly selected tag as illustrated in FIG. 5. Referring to FIG. 5, when the selected tag is changed, reference contents 501 and a series list 502 of the 3D guide screen are maintained and a related-contents list linked to the y-axis that is constructed as the related-contents including the newly selected tag and is displayed.

The method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A contents guide three dimensional (3D) navigation system, comprising:
a contents classification module to classify contents based on at least one tag defined in the contents; and
a navigation module to provide a list of the classified contents via a 3D guide screen constituted by an x axis, a y axis, and a z axis,
wherein the navigation module links the list of the classified contents to the x axis, the y axis, and the z axis, each of the x axis, the y axis and the z axis being linked on different standards.

2. The contents guide 3D navigation system of claim 1, wherein the at least one tag is defined by a user or a contents provider that provides the contents, and is a keyword corresponding to at least one contents information of a genre of the contents, a title, an actor, a broadcasting time of the contents, channel information, and a name of the contents provider.

3. The contents guide 3D navigation system of claim 1, wherein the navigation module links a series list of the contents to one of the x axis, the y axis, and the z axis, links a list of contents commonly including one tag from among the at least one tag to another axis, and links a list of contents commonly including another tag from among the at least one tag to a remaining axis.

4. A contents guide 3D navigation system, comprising:
a contents classification module to classify related-contents related to contents based on at least one tag defined in the contents, when the contents is selected by a user; and
a navigation module to provide a list of the classified related-contents via a 3D guide screen constituted by an x axis, a y axis, and a z axis,
wherein the navigation module links the list of the classified related-contents to the x axis, the y axis, and the z axis, each of the x axis, the y axis and the z axis being linked on different standards, and displays, on the 3D guide screen, the list of the related-contents linked to at least one of the x axis, the y axis, and the z axis.

5. The contents guide 3D navigation system of claim 4, wherein the navigation module links a series list of the contents to the x axis, links a list of related-contents commonly including a tag selected by the user from among the at least one tag to the y axis, and links a list of related-contents commonly including remaining tags to the z axis.

6. The contents guide 3D navigation system of claim 5, wherein the navigation module displays, on the 3D guide screen, the series list linked to the x axis and the list of the related-contents linked to the y axis together with a tag list of the tag defined in the contents.

7. The contents guide 3D navigation system of claim 5, wherein the navigation module displays, on the 3D guide screen, the list of the series list linked to the x axis and the list of the related-contents linked to the y axis together with a list of the tag defined in the contents, and updates the list of the related-contents linked to the y axis as a list of related-contents corresponding to a selected tag from among the list of the related-contents linked to the z axis, when the selected tag is selected from the tag list.

8. A contents guide 3D navigation method in a system including a contents classification module and a navigation module, the method comprising:
classifying, by the contents classification module, related-contents related to contents based on at least one tag defined in the contents; and
providing, by the navigation module, a list of the classified related-contents via a 3D guide screen constituted by an x axis, a y axis, and a z axis,
wherein the providing links the list of the classified related-contents to the x axis, the y axis, and the z axis, each of the x axis, the y axis and the z axis being linked on different standards, and displays, on the 3D guide screen, the list of the related-contents linked to at least one of the x axis, the y axis, and the z axis

9. The contents guide 3D navigation method of claim 8, wherein the at last one tag is defined by a user or a contents provider that provides the contents, and is a keyword corresponding to at least one contents information of a genre of the contents, a title, an actor, a broadcasting time of the contents, channel information, and a name of the contents provider.

10. The contents guide 3D navigation method of claim 8, wherein the classifying comprises:
reading a tag defined in selected contents when the contents is selected by the user; and
classifying a series of the contents and related-contents commonly including a tag, for each of the read tag.

11. The contents guide 3D navigation method of claim 10, wherein the providing links a series list of the series of the contents to the x axis, links a list of related-contents commonly including a tag selected by the user from among the related-contents classified for each tag to the y axis, and links a list of related-contents commonly including remaining tags to the z axis.

12. The contents guide 3D navigation method of claim 11, wherein the providing comprises:
displaying, on the 3D guide screen, the series list linked to the x axis and the list of the related-contents linked to the y axis together with a tag list of the tag; and
updating the list of the related-contents linked to the y axis as a list of related-contents corresponding to a selected tag from among the list of the related-contents linked to the z axis, when the selected tag is selected from the tag list.
